(19) United States
(12) Patent Application Publication
(10) Pub. No.: US 2003/0096096 A1
(43) Pub. Date: May 22, 2003

(54) Plastic rail system reinforced with fiberglass thermoplastic composites

(76) Inventors: Byeong H. Jo, Blue Bell, PA (US); Richard S. Duncan, Royersford, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/988,985

(22) Filed: Nov. 19, 2001

(51) Int. Cl. B32B 27/04

(52) U.S. Cl. 428/297.4; 428/299.4

(57) ABSTRACT

The present invention relates to a consolidated form of the commingled continuous filaments of glass fibers and polymeric fibers as reinforcement. The consolidation of the commingled fibers into composite reinforcement can be used in a continuous form or bulk molding compound pellets. The consolidation of the commingled fibers into composite reinforcement can be made in-situ during in-line extrusion of the final end product extrudate, or prepared as a tape or rod and incorporated into an off-line extrusion of final product. The bulk molding pellets are used solely or diluted with an addition of polymeric material for mono or co-extrusion or compression molding.

### FIELD OF THE INVENTION

The present invention relates to a consolidated form of the commingled continuous filaments of glass fibers and polymeric fibers as reinforcement.

### BACKGROUND OF THE INVENTION

Most fence and rail materials are either traditional lumber or thermoplastics. Typical plastics in these applications are PVC (polyvinyl chloride) and polyethylene. PVC typically does not have the strength and rigidity of wood and lumber and therefore, the rail for the fence and railing needs the steel or aluminum reinforcement channel inside the rail. These metal reinforcements are prone to corrosion attack, and lose strength in long-term endurance. Also, the problem exists as to the dark color of thermoplastic products. The dark color fence and rail made out of PVC or other polymeric materials have not been successful in the past. The products show bowing due to differences in expansion and contraction between the two different sides of the product upon exposure of sunlight. In addition, the dark color absorbs heat readily and the resultant uneven heat build-up causes this deformation. An additional problem is the lack of long-term stiffness of the products. It has limited the rail span between the posts to less than traditional lumber.

One of the objectives of the present invention is the production of a high strength plastic alternative to the traditional wrought iron or aluminum ornamental rail and fence. Metal fences and rails are constantly under the threat of corrosion attack, and need periodic painting. To date, there have not been any non-composite products with the necessary performance properties and aesthetic appearance comparable to these metal products. In that sense, there have not been any thermoplastic composite products in the market. The present invention discloses thermoplastic composite products that resemble wrought iron, and aluminum wrought iron alternative, but are maintenance-free, kink-free, light and perform equally as well.

An additional objective is to make the dark color thermoplastic post and rail fence (e.g., split post and rails) possible. The fiberglass reinforcement stabilizes the uneven contraction and expansion, in spite of different heat buildup on the surface.

A further objective of the present invention is providing non-metallic heavy duty rail and fence systems for use in industrial and commercial applications. The metallic railing in an industrial atmosphere is often exposed to chemical gases or acids and is prone to corrosion attack. The integrity of the industrial railing is critical for the safety of those in the workplace. The thermoplastic railing system that is strengthened by reinforcing tapes or rods of fiberglass/thermoplastic polymer composite provides superior strength and rigidity to its metal counterparts.

### BRIEF DESCRIPTION OF THE DRAWINGS

FIG. 1 is a front partial view of a fence or railing construction using the preferred composite.

FIG. 2 is a frontal view of a post and rail fence.

FIGS. 3-10 are cross-sectional views of a fence construction using the preferred composite building materials of this invention.

FIG. 11 is a front partial view of an alternative post and rail fence.

### DESCRIPTION OF THE PREFERRED EMBODIMENTS

The present invention relates to a consolidated form of the commingled continuous filaments of glass fibers and polymeric fibers as reinforcement. The consolidation of the commingled fibers into composite reinforcement may be made in-situ during in-line extrusion of the final end product extrudate, or, alternatively, prepared as tape or rod and incorporated into an off-line extrusion of final product. In either case, the materials of the present invention are incorporated through a cross-head die into the polymer extrudate. In this way, the matrix polymer encapsulates the inside and outside surface of the hollow profile product.

Another production process is to subject these commingled fibers through pultrusion and its die, followed by overlay extrusion of a cap stock polymer using a separate extruder, all in-line. In this case, the capstock polymer covers only the outside surface. The commingled fibers are heated prior to entering into the series of forming dies where they are consolidated. In a further embodiment, a helical winding machine may be added in order to enhance the strength in hoop direction before the die entrance.

A preferred material for use in the present invention is Twintex™ composite tapes, supplied by the Saint-Gobain Corporation. The Twintex materials are present in various forms, such as commingled roving and fabrics (uni-directional, or multi-axial woven fabric or tapes). The commingled roving is consolidated through a pultrusion die into a thermoplastic composite tape or rod. It contains glass fibers dispersed uniformly in a longitudinal direction. The polymeric fiber that becomes the consolidation matrix may be either polyethylene (PE), polypropylene (PP) or polyesters (PBT or PET). The functional need of the end product and extrusion process will determine the fiberglass contact in the Twintex material and the volume of the consolidated reinforcement. A “standard” Twintex material contains about 40%-75% glass fiber content.

Although polyethylene and polypropylene Twintex tapes were used in the testing of the present invention, any polymeric materials would be acceptable to be a commingled fiber with glass fiber, as long as they are capable of being fiberized and made compatible to the intended matrix polymers.

A further aspect of the present invention relates to the compatibility of the commingled polymeric fiber material with the matrix polymer of the final extrusion product. These materials need adhesion with each other in order to be effective. In the testing of the present invention, a polyethylene-glass fiber Twintex reinforcement/HMPE polymer, polypropylene-glass fiber Twintex reinforcement/HMPE polymer, polyethylene-glass fiber Twintex reinforcement/polyethylene polymer, and polypropylene glass fiber Twintex reinforcement/polyethylene polymer were used. The combinations of the polymers of the composite reinforcement and the base polymers are numerous, and may be customized in order to meet the needs of the final product performance requirements.

The Twintex composite reinforcement allows for the base polymeric material with a higher impact in both cold and ambient temperatures, lower heat expansion coefficient, higher tensile and flexural strength, as well as higher rigidity. These Twintex reinforcements (rods, tapes or fabrics) are embedded into strategic locations of the basic polymeric material.

In a further preferred embodiment of the present invention, a hybrid of Twintex filaments with carbon fibers may be utilized, with the combination providing for higher stiffness and for easier material handling, as well as providing for a lighter weight product as well.

The materials of the present invention may be manufactured by a pultrusion process, the mechanics of which are familiar to those of skill in the art. The process utilizes continuous Twintex fibers (roving or yarn), and other fiber as necessary, in order to process uniaxially reinforced profiles with exceptional longitudinal strength. Modification of the basic process allows for the incorporation of transverse reinforcements. Important components of the pultrusion process are: (1) heating, wherein the thermoplastic fibers are melted, and (2) the consolidation and shape forming at the tooling die, in which relatively high pressure is involved.

In a further preferred embodiment, the commingled, continuous filaments of glass fibers and polymeric fibers including from about 40%-80% glass fiber content. These commingled, continuous filaments may further include carbon fibers and/or aramid fibers. Furthermore, a bulk molding compound may be made out of the commingled, continuous filaments of glass fibers and polymeric fibers. This bulk molding compound may be compression molded into particular building products, such as fence, rail, post and deck materials. The commingled, continuous filaments may be added through, e.g., a helical winding machine.

In a further preferred embodiment of the present invention, the bulk molding compound includes from about 20%-80% glass fiber content, or is diluted with an addition of polymeric pellets to a glass fiber content to 10% or greater in the final product. The thermal expansion and contraction of the composite building material is controlled by the use of the bulk molding compound.

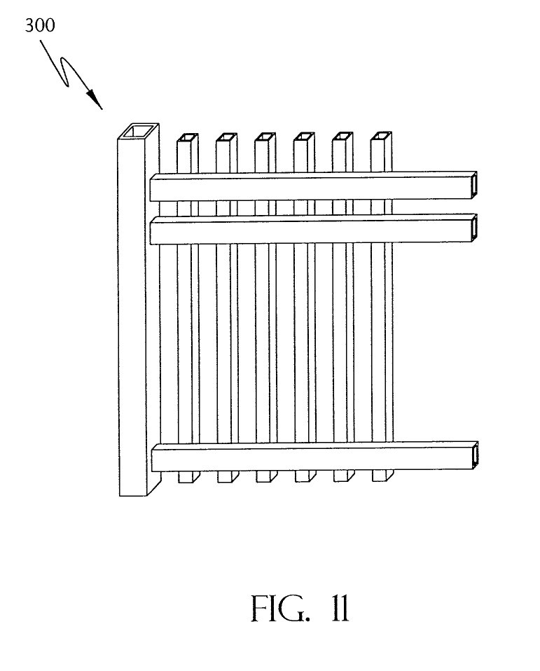

With reference to FIGS. 1 through 10 thereof, a picket and railing construction 100, a post and rail 200 and fence 300 will now be described. Turning to FIG. 1, this partial post and rail construction includes rails 10 and 20, connected by posts 11. Note the cross-sections 12 and 13 of rails 10 and 20 include Twintex rods 14 and 15.

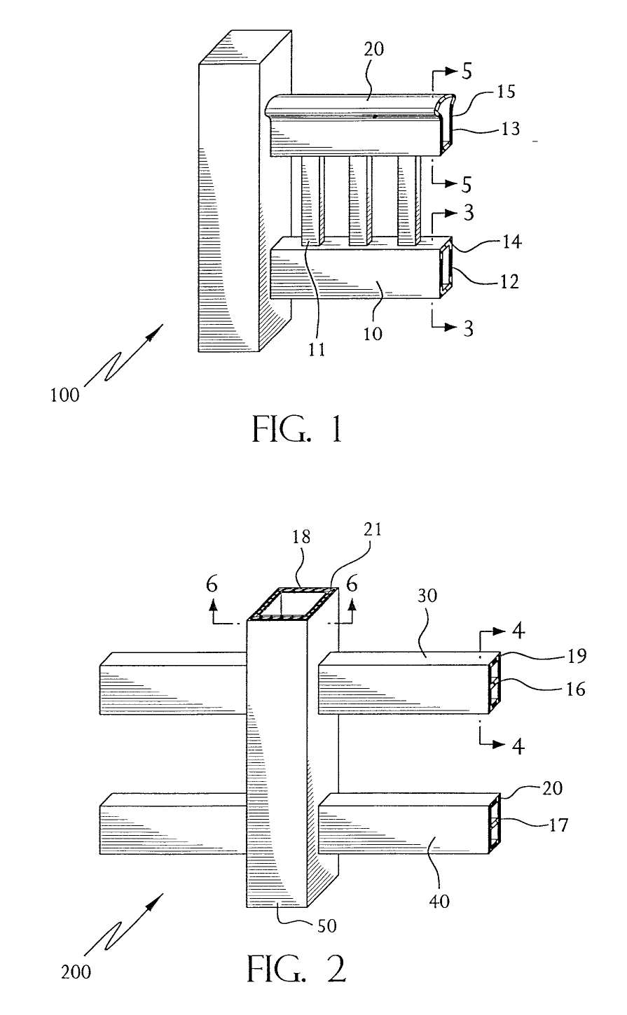

In FIG. 2, partial post and rail construction 200 includes rails 30 and 40 connected by post 50. Note the cross sections 16 and 17 of rails 30 and 40 and cross section 18 of post 50 include Twintex rods 19, 20 and 21, respectively.

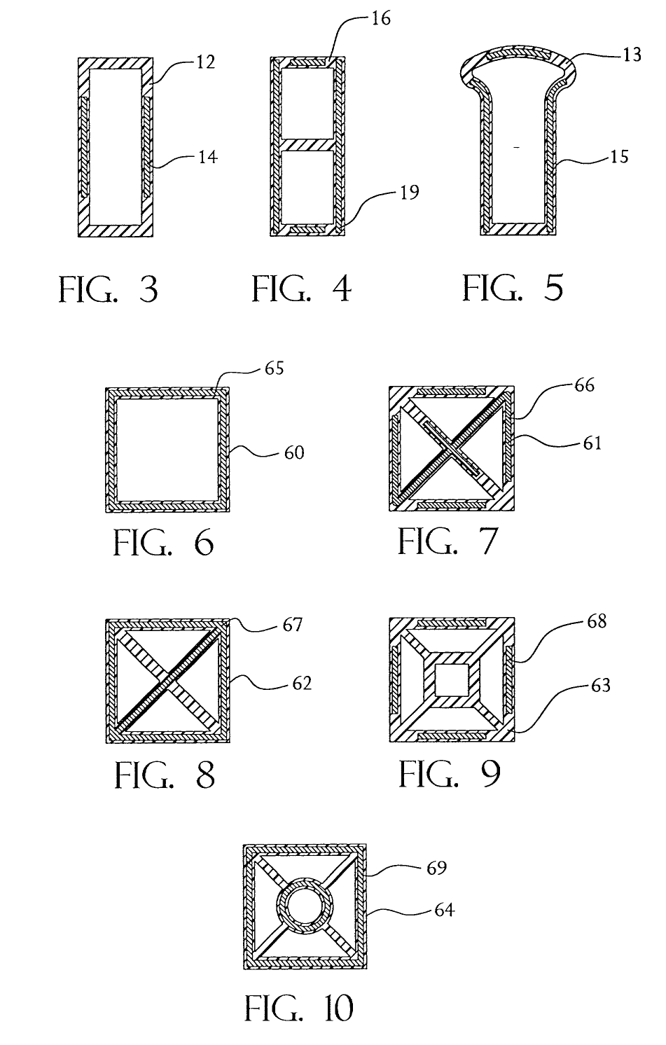

With reference to FIGS. 3 through 5, cross sections 12, 16 and 13 corresponding to rails 10, 30 and 20 respectively are represented, with related Twintex rods 14, 19 and 15 as shown.

Similarly, in FIGS. 6-10, cross sections of various rails are displayed (60-64, respectively) along with Twintex rods (65-69, respectively).

Twintex may also be manufactured as a bulk molding compound (BMC) with a length of from about 3/16 inch to 2 inches. These long fibers may be processed through an extruder with a die that is specifically designed for processing of long fiber reinforced plastics. These BMC compounds can be diluted with other polymeric pellets depending on the need of processability, functional demand or cost reduction.

In a further preferred embodiment of the present invention, a rail of more than an eight foot span between the two posts, on a sixteen foot length encompassing two sections with three posts with a Twintex reinforcement, is a possible alternative. The use of a hybrid reinforcement of Twintex commingled fiber and other reinforcement fibers, such as carbon fiber and/or aramid fibers is also possible.

Thus, the bulk molding compounds used for purposes of the present invention may be employed for compression molding into building products including fence, rail, post, deck, etc.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

We claim:

1. A polymer composite building material, comprising a commingled, continuous filament of glass fibers and polymeric fibers as reinforcement, wherein the polymeric fiber that becomes the consolidation matrix is a fiberizable polymer selected from the group consisting of polyethylene, polypropylene and polyesters.

2. The polymer composite building material of claim 1, wherein the consolidation of the commingled fibers into composite reinforcement is made in-situ during in-line extrusion or pultrusion of the final end product.

3. The polymer composite building material of claim 1, wherein the consolidation of commingled fibers into composite reinforcement is prepared as a tape or rod, and incorporated into an off-line extrusion of the final product.

4. The polymer composite building material of claim 1, wherein the commingled, continuous filaments of glass fibers and polymeric fibers are incorporated through a cross-die head into a polymer extrudate.

5. The polymer composite building material of claim 1, wherein the commingled, continuous filaments contain glass fibers dispersed uniformly in a longitudinal direction during extrusion or pultrusion.

6. The polymer composite building material of claim 1, wherein the commingled, continuous filaments of glass fibers and polymeric fibers include from about 40%-80% glass fiber content.

7. The polymer composite building material of claim 1, wherein the commingled, continuous filaments of glass fibers and polymeric fibers further include carbon fibers and/or aramid fibers.

8. The polymer composite building material of claim 1, wherein a bulk molding compound is made of the commingled, continuous filaments of glass fibers and polymeric fibers.

9. The polymer composite building material of claim 8, wherein the bulk molding compound made of the commingled, continuous filaments of glass fibers and polymeric fibers are compression molded into building products.

10. The polymer composite building material of claim 9, wherein the building products are selected from the group consisting of fence, rail, post and deck materials.

11. The polymer composite building material of claim 5, wherein the commingled, continuous filaments are added through a helical winding machine.

12. The polymer composite building material of claim 8, wherein the bulk molding compound includes from about 20%-80% glass fiber content, or is diluted with an addition of polymeric pellets to a glass fiber content to 10% or greater in the final product.

13. The polymer composite building material of claim 8, wherein the thermal expansion and contraction is controlled by the use of the bulk molding compound.
